(19) United States
(12) Patent Application Publication
(10) Pub. No.: US 2017/0262708 A1
(43) Pub. Date: Sep. 14, 2017

(54) Surveillance camera image pan tilt roll zoom (PTRZ) control from a 3D touch user interface apparatus and method of operation

(71) Applicants: Feng Chi Wang, Austin, TX (US); Hans Kahler, Austin, TX (US)

(72) Inventors: Feng Chi Wang, Austin, TX (US); Hans Kahler, Austin, TX (US)

(21) Appl. No.: 15/069,783

(22) Filed: Mar. 14, 2016

(51) Int. Cl. G06K 9/00; H04N 5/232; G06F 3/0488

(52) U.S. Cl. CPC G06K 9/00771; G06F 3/0488; H04N 5/23222; H04N 5/23206; G06F 2203/04802; G06F 2203/04806; G06F 2203/04808

(57) ABSTRACT

A logic control circuit controls a remote pan tilt zoom (PTZ) camera by transmitting commands and displaying the resulting image on a 3D touch sensitive display. When pressure is measured at two or three locations of the display, a new centerpoint is determined. The relative force applied at the pair of locations causes a determination of desired direction and desired rate of change of zoom or roll. A bounding box is added to the presently displayed image and commands are transmitted to the PTZ camera to fulfill the desired change in orientation and image size. Several limits and interrupts are set to stop the zooming process. The process includes measuring and comparing the force applied incident to a 3D touch user interface integrated with a display at two locations.

### CROSS-REFERENCE TO RELATED APPLICATIONS

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Field of the Invention

The disclosure relates to a control system for electronic video cameras which are remote from 3D touch user interface operator consoles. Physical forces are measured for transformation into apparatus commands.

Description of Related Art

As is known, a pan-tilt-zoom camera (PTZ camera) is a camera that is capable of remote directional and zoom control.

In television production, PTZ controls are used with professional video cameras in television studios and referred to as camera robotics. These systems can be remotely controlled by automation systems.

PTZ is an abbreviation for pan, tilt and zoom and reflects the movement options of the camera. Other types of cameras are ePTZ or virtual pan-tilt-zoom (VPTZ) where a high-resolution camera digitally zooms and pans into portions of the image, with no physical camera movement. Ultra-low bandwidth surveillance streaming technologies use VPTZ to stream user-defined areas in higher quality without increasing overall bandwidth usage. Surveillance cameras of this type are often connected to a digital video recorder which records the full field of view in full quality.

PTZ Cameras are commonly used in applications such as surveillance, video conferencing, live production, lecture capture and distance learning. Other cameras (PTRZ) include functionality to roll.

The PTZ or PTRZ controls are generally sold separately without the cameras.

As is known, standard smartphones have been introduced with touch sensitive displays. The iPhone 6s and iPhone 6s Plus are the first iPhones to feature “3D touch”. 3D Touch allows the iPhone to detect how hard and the location pressure is applied.

In some enablements, when pressure is applied on the screen, the glass bends a tiny bit. A capacitive sensor under the glass measures the distance between the sensor and a finger to measure force. Other enablements may utilize piezoelectric or magnetic measurements of force.

What is needed is a more direct interaction between a camera operator and the scene presented than a keyboard-mouse-single cursor-menu selection conventional system.

### BRIEF SUMMARY OF THE INVENTION

A video camera is controlled from a phone or other user interface by placing two fingers on the glass display and applying relatively different degrees of force. The center of view is shifted halfway between two finger placements and the size of the view port is determined by zooming-in or zooming-out from the center according to the force applied by a first finger relative to a second finger.

A logic control circuit controls a remote pan tilt zoom (PTZ) camera by transmitting commands and displaying the resulting image on a 3D touch sensitive display. When pressure is measured at two locations of the display, a new centerpoint is determined. The relative force applied at the pair of locations causes a determination of desired direction and desired rate of change of zoom. A bounding box is added to the presently displayed image and commands are transmitted to the PTZ camera to fulfill the desired change in orientation and image size. Several limits and interrupts are set to stop the zooming process. The process includes measuring and comparing the force applied incident to a 3D touch user interface integrated with a display at two locations. The invention transforms pressure and location of two fingers on a display into PTZ commands executed by a camera and causes a transformed image to be presented on the display.

### BRIEF DESCRIPTION OF THE SEVERAL VIEWS OF THE DRAWINGS

The foregoing and other objects, aspects, features, and advantages of the disclosure will become more apparent and better understood by referring to the following description taken in conjunction with the accompanying drawings, in which:

FIG. 1 is a block diagram of the system;

FIGS. 2 and 3 schematic diagrams of circuit embodiments of a logic control circuit; and

FIG. 4 is a flowchart of a method for determining PTZ commands;

FIGS. 5 A and 5 B illustrate a clock-wise and counter-clock-wise roll input scenario; and

FIG. 6 depicts a computing device suitable for equivalent functionality by performing the method.

### DETAILED DESCRIPTION OF THE INVENTION

A logic control circuit controls a remote pan tilt zoom (PTZ) camera by transmitting commands and displaying the resulting image on a 3D touch sensitive display.

As is known, executable instructions stored in non-transitory media when performed by a processor are equivalent to a circuit in causing commands to be transmitted and images to be displayed.

When pressure is measured at two locations of the display, a new centerpoint is determined.

When location data is provided for two locations of pressure, a mean coordinate value is determined and provided a transformation of the centerpoint of a viewport.

The relative force applied at the pair of locations causes a determination of desired direction and desired rate of change of zoom.

When exactly two locations receive pressure or force, that is a triggering event to determine whether a zoom-out or zoom-in is desired according to the configuration of the user interface. The greater the difference in pressure of a first location over a second location, the greater the speed of zoom. Less difference in pressure slows the zoom. A user selected setting determine whether the left or right pressure point causes zoom-in or the converse.

A bounding box is added to the presently displayed image and commands are transmitted to the PTZ camera to fulfill the desired change in orientation and image size.

In other words, a rectangular figment is inserted into the displayed image using the current aspect ratio but centered at the mean coordinate of a pair of locations to indicate where the viewport will be and as pressure is applied, the size of the rectangular figment is adjusted to match what the camera will be capturing and transmitting when it receives PTZ commands.

Several limits and interrupts are set to stop the zooming process. There are maximum and minimum amounts that can be zoomed to and zooming will stop. Or if the number of locations of pressure changes from two, the zooming will stop.

The process includes measuring and comparing the force applied incident to a 3D touch user interface integrated with a display at two locations. The apparatus performing a method transforms two physical forces into commands performed by a display or by a remote camera or both.

The invention further includes in an embodiment a means for controlling roll of the image by electronic shifting or mechanical servos as follows: The logic circuit apparatus for controlling a remote camera from a 3D touch device also has a circuit to transmit a roll command through a network interface wherein a roll command is one of clock-wise angular movement and counter-clock-wise angular movement; a circuit to receive a plurality of touches from a 3D touch device; a circuit to trigger on the event of receiving exactly three touch data tri-tuples; a circuit to determine a rotational pivot from the x and y coordinates of three touch data tri-tuples; a circuit to receive the force component of touch data tri-tuples; a circuit to determine inequalities of force applied at each of three touch data tri-tuples; a circuit to determine an anchor point by selecting a first touch location which has less force measured than a second touch location and less force measured than a third touch location; a circuit to determine an inequality of force measured at the two non-anchor points; a circuit to transmit a clock-wise roll command when the second touch location has less force measured than the third touch location; a circuit to transmit a counter-clock-wise roll command when the third touch location has less force measured than the second touch location; and a circuit to transmit a stop roll command when the differences in force measurements is below a threshold.

These above circuits are communicatively interconnected and further coupled to a camera and to a 3D touch user interface integrated with an image display which presents video data captured by the camera.

In an embodiment, the logic circuit also has a circuit to receive images captured by a video camera; a circuit to transform received images; a circuit to transmit transformed images to a 3D touch interface equipped display apparatus; a circuit to receive 3D sensor data from a 3D touch interface equipped display apparatus; and a circuit to transmit pan tilt zoom (PTZ) commands via a network interface.

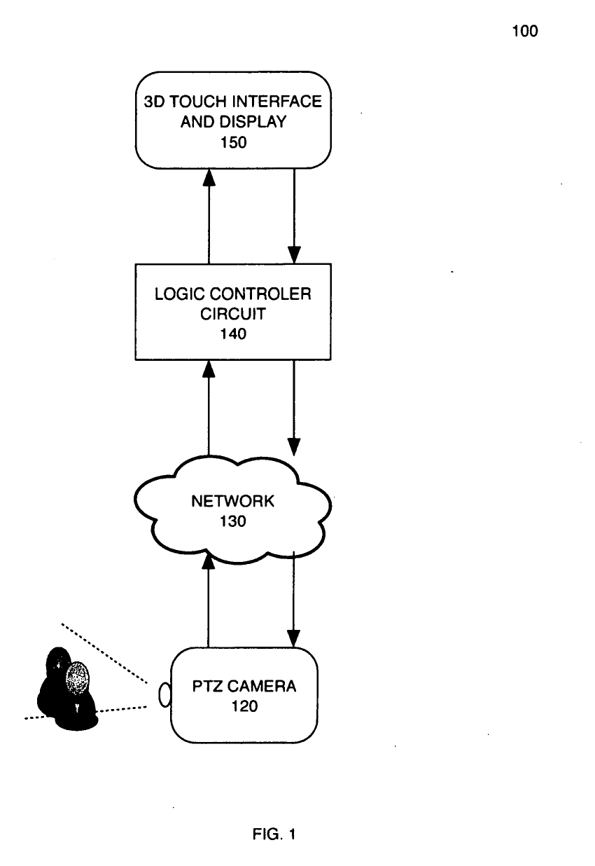

Referring now to the figures, a system 100 shown in FIG. 1 has a logic controller circuit 140 (controller); the controller is communicatively coupled to at least one Pan Tilt Zoom (PTZ) camera 120, via a network 130; and is further coupled to at least one 3D touch interface equipped display apparatus 150.

The at least one PTZ camera has electronic circuits or mechanical linkages which respond to commands to control the orientation and size of images captured by its sensor devices. The at least one 3D touch interface equipped display apparatus has a display which measures, records, and transmits pressure centered on at least two locations on its display surface and the x and y coordinate of the at least two locations.

The network has a duplex data communication system which receives and delivers images in one direction and receives and delivers camera control commands in the reverse direction to and from a plurality of wireless devices.

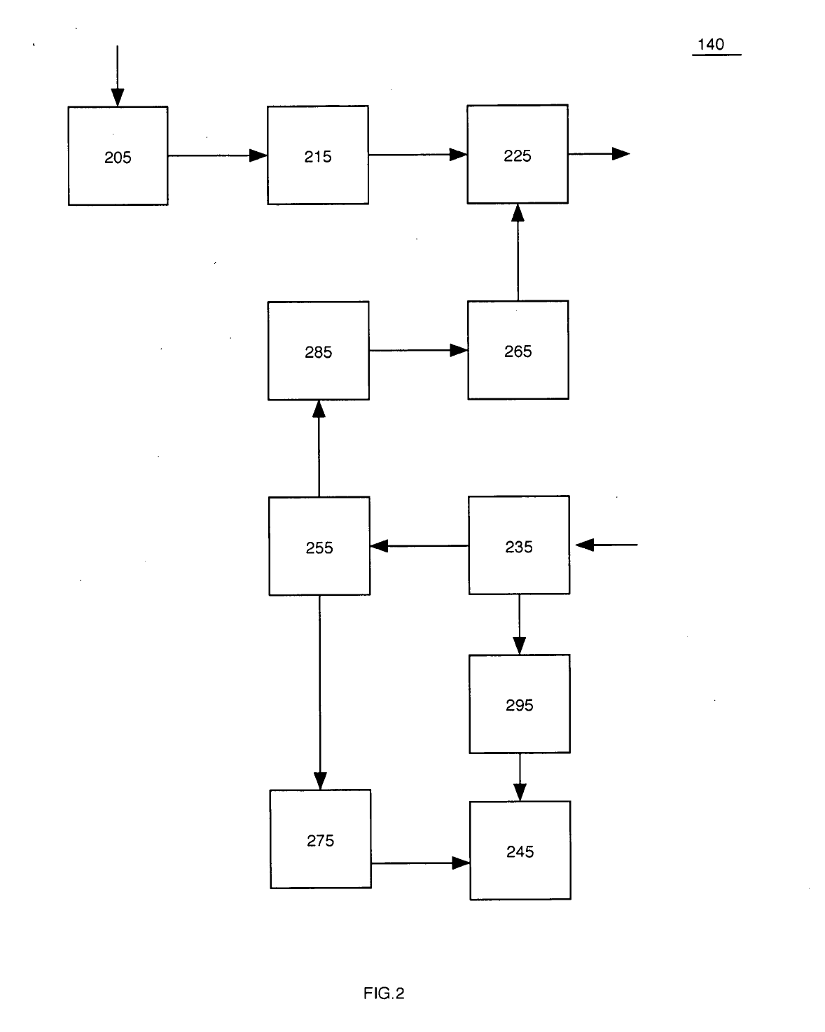

In further detail, FIG. 2 shows the logic controller circuit 140 which has a circuit to receive images captured by a video camera 205; a circuit to transform received images 215; a circuit to transmit transformed images to a 3D touch interface equipped display apparatus 225; a circuit to receive 3D sensor data from a 3d touch interface equipped display apparatus 235; and a circuit to transmit pan tilt zoom (PTZ) commands via a network interface 245.

The logic controller circuit also has a circuit to determine a new centerpoint from two touches on the 3D touch interface 255; a circuit to insert a box of a current aspect ratio into the current displayed image surrounding the new centerpoint 265; a circuit to transform the new centerpoint into a pan tilt zoom (PTZ) command 275; a circuit to transform the current displayed image by stretching the existing image to match dimensions of the box 285; and a circuit to determine a zoom component of a pan tilt zoom command from two separate forces on the 3D touch interface 295.

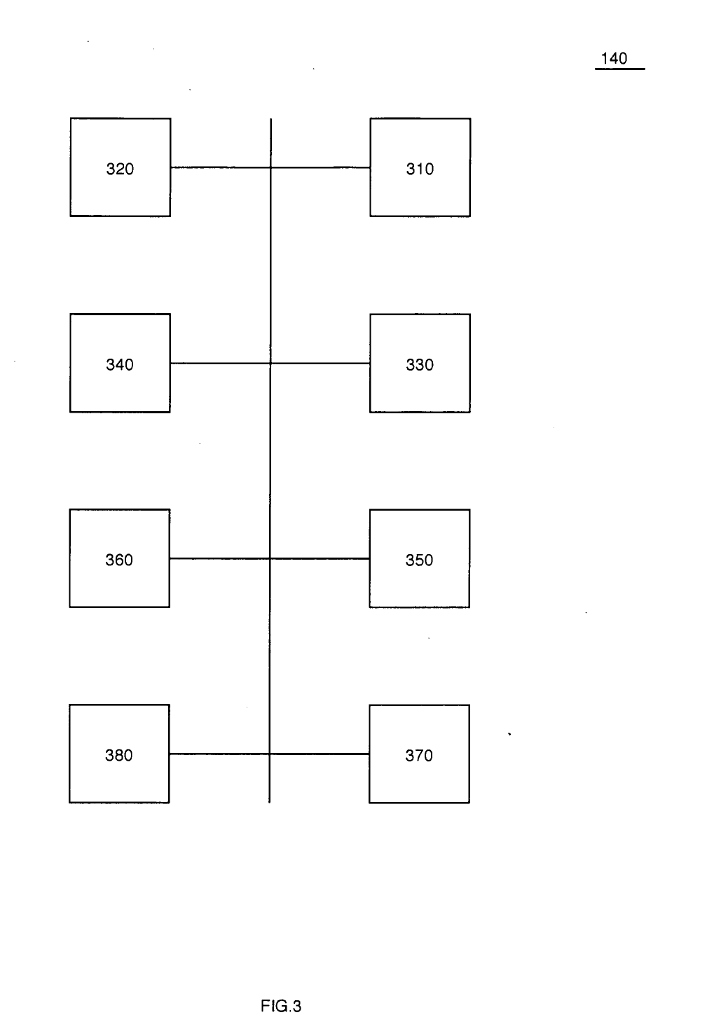

In further detail FIG. 3 illustrates a circuit to determine a zoom component of a PTZ command which has a circuit to determine a condition when the system is zooming 310; a circuit to determine a condition when the system is at a zoom limit 320; a circuit to determine a condition when a left tap force exceeds a right tap force 330; a circuit to determine a condition when tap forces are applied in two locations of the 3D touch interface 340; a circuit to determine a magnitude of a difference between a 1st tap force and a 2nd tap force 350; a circuit to determine a rate of zoom as a function of the magnitude of the difference in force 360; a circuit to emit a zoom-in command when the left tap force exceeds a right tap force is true and to emit a zoom-out command when the left tap force exceeds a right tap force is false 370; and a circuit to emit a stop zooming command when the condition that the system is at a zoom limit is true or when the condition the system is zooming is true and tap forces are applied in two locations is false 380.

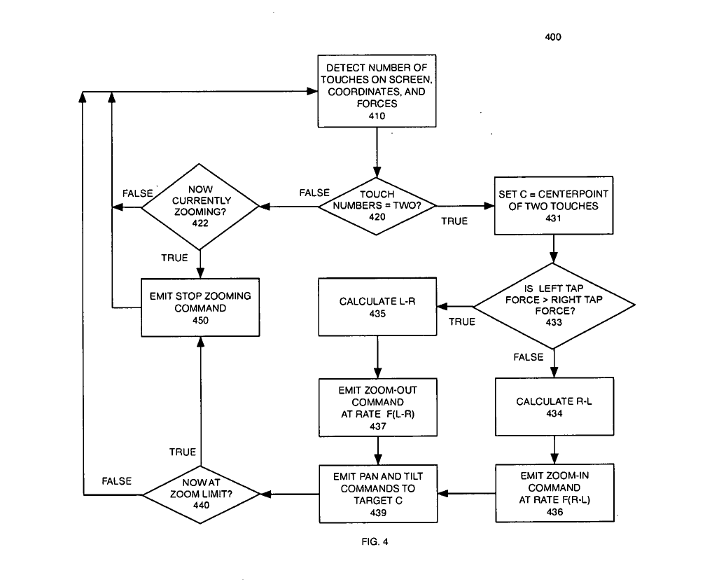

A method 400 is shown in FIG. 4 for operation of a camera logic controller by receiving from a 3D touch screen device a plurality of touch triplet data 410; determining a touchcount condition that the plurality is numerically equal to two 420; on the condition that touchcount is true, determining a centerpoint equidistant between two touches, and setting an array C to said centerpoint 431; determining at least one zoom command; emitting at least one zoom command; and emitting a pan command and a tilt command to target C 439; and monitoring the 3D touch screen for touch triplet data.

The method also includes determining a condition when the camera logic controller is at its zoom limit 440; and emitting a stop zooming command 450.

The method also includes on the condition that touchcount is false, determining a currently zooming condition that the camera logic controller is emitting zoom commands; on the condition that currently zooming is true, emitting a stop zooming command 450.

One example of emitting at least one zoom command method includes determining a left tap force greater than right tap force condition 433; on the condition that left tap force greater than right tap force is true, calculating left force minus right force 435, and emitting a zoom out command at a rate proportional to the magnitude of the difference between left force and right force 437.

Additional steps include on the condition that left tap force greater than right tap force is false, calculating a right force minus left force 434; and emitting a zoom in command at a rate proportional to the magnitude of the difference between right force and left force 436.

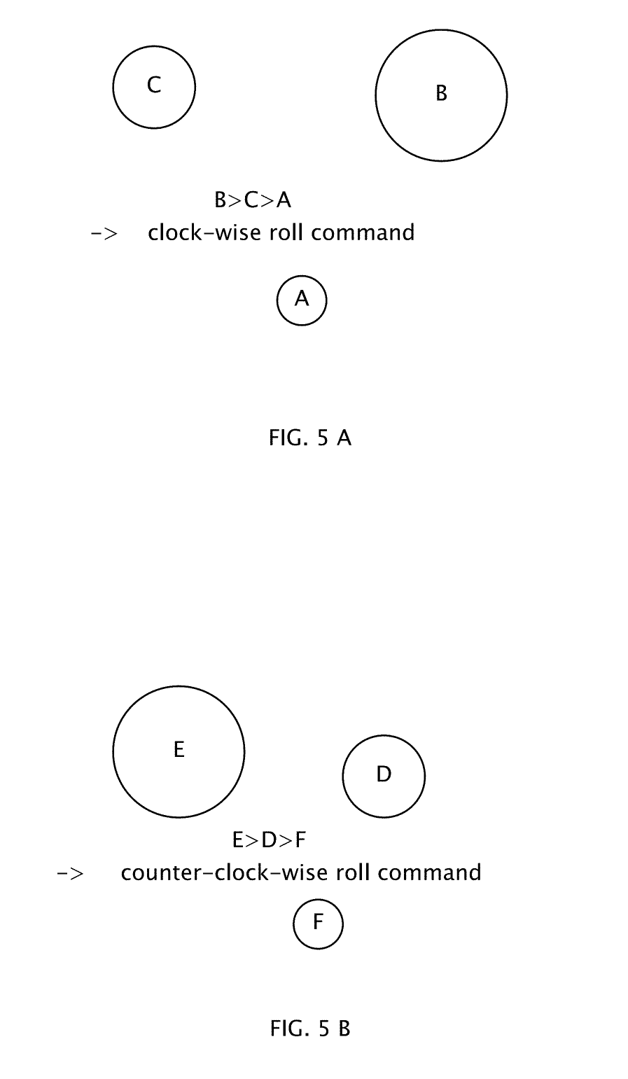

FIG. 5 A illustrates a 3D touch interface input to evoke a clock-wise roll command and FIG. 5 B illustrates a 3D touch interface input to evoke a counter-clock-wise roll command. On the condition that all forces are above a threshold, Of the three forces, the inequality between the two larger cause roll in one direction or the other. The circumference of the circles suggest the deformation which is measured as force. It is not drawn to scale.

In general the process requires simultaneously receiving a stream of video images from a network; transmitting the stream of video images to the 3D touch screen device; and wherein touch triplet data comprises location coordinates and touch force in an array.

Embodiments of the invention include both software and hardware.

One aspect of the invention is a method for operation of a camera logic controller including the steps: receiving from a 3D touch screen device a plurality of touch triplet data; determining a touchcount condition that the plurality is numerically equal to two; on the condition that touchcount is true, determining a centerpoint equidistant between two touches, and setting an array C to said centerpoint; determining at least one zoom command; emitting at least one zoom command; and emitting a pan command and a tilt command to target C; and monitoring the 3D touch screen for touch triplet data.

In an embodiment the method further includes determining a condition when the camera logic controller is at its zoom limit; and emitting a stop zooming command.

In an embodiment the method further includes on the condition that touchcount is false, determining a currently zooming condition that the camera logic controller is emitting zoom commands; on the condition that currently zooming is true, emitting a stop zooming command.

In an embodiment, emitting at least one zoom command includes: determining a left tap force greater than right tap force condition; on the condition that left tap force greater than right tap force is true, calculating left force minus right force, and emitting a zoom out command at a rate proportional to the magnitude of the difference between left force and right force.

In an embodiment the method further includes on the condition that left tap force greater than right tap force is false, calculating a right force minus left force; emitting a zoom in command at a rate proportional to the magnitude of the difference between right force and left force.

In an embodiment the method further includes receiving a stream of video images from a network; transmitting the stream of video images to the 3D touch screen device; and wherein touch triplet data comprises location coordinates and touch force in an array.

Another aspect of the invention is a system which includes a logic controller circuit (controller); the controller communicatively coupled to at least one Pan Tilt Zoom (PTZ) camera, via a network; and further coupled to at least one 3D touch interface equipped display apparatus.

In an embodiment, the at least one PTZ camera includes electronic circuits or mechanical linkages which respond to commands to control the orientation and size of images captured by its sensor devices.

In an embodiment, at least one 3D touch interface equipped display apparatus includes a display which measures, records, and transmits pressure centered on at least two locations on its display surface and the x and y coordinate of the at least two locations.

In an embodiment, a network includes a duplex data communication system which receives and delivers images in one direction and receives and delivers camera control commands in the reverse direction to and from a plurality of wireless devices.

In an embodiment, the logic controller includes a circuit to receive images captured by a video camera; a circuit to transform received images; a circuit to transmit transformed images to a 3D touch interface equipped display apparatus; a circuit to receive 3D sensor data from a 3D touch interface equipped display apparatus; and a circuit to transmit pan tilt zoom (PTZ) commands via a network interface.

In an embodiment, the system also includes a circuit to determine a new centerpoint from two touches on the 3D touch interface; a circuit to insert a box of a current aspect ratio into the current displayed image surrounding the new centerpoint; a circuit to transform the new centerpoint into a pan tilt zoom (PTZ) command; a circuit to transform the current displayed image by stretching the existing image to match dimensions of the box; and a circuit to determine a zoom component of a pan tilt zoom command from two separate forces on the 3D touch interface.

In an embodiment, the circuit to determine a zoom component of a PTZ command includes a circuit to determine a condition when the system is zooming; a circuit to determine a condition when the system is at a zoom limit; a circuit to determine a condition when a left tap force exceeds a right tap force; a circuit to determine a condition when tap forces are applied in two locations of the 3D touch interface; a circuit to determine a magnitude of a difference between a 1st tap force and a 2nd tap force; a circuit to determine a rate of zoom as a function of the magnitude of the difference in force; a circuit to emit a zoom-in command when the left tap force exceeds a right tap force is true and to emit a zoom-out command when the left tap force exceeds a right tap force is false; and a circuit to emit a stop zooming command when the condition that the system is at a zoom limit is true or when the condition the system is zooming is true and tap forces are applied in two locations is false.

As is known, executable instructions stored on non-transitory media cause a processor in a computing device to perform the equivalent function as a logic circuit

Generally a computing device can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

In one embodiment, a computing device provides functionality of a web server. In some embodiments, a web server comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems, of Santa Clara, Calif.

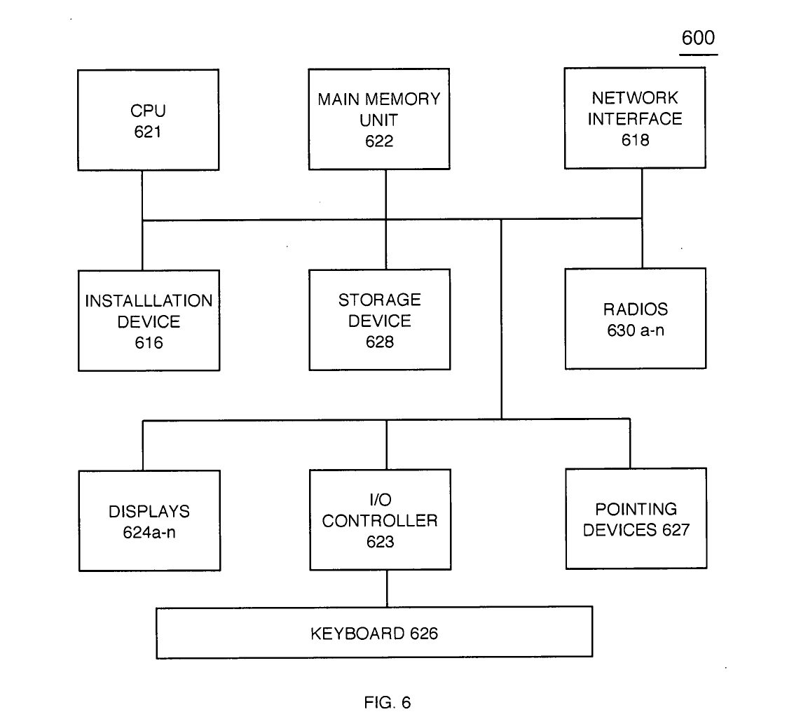

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, Ti, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10 and WINDOWS VISTA, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; Nokia of Finland; Hewlett-Packard Development Company, L.P. and/or; Sony Ericsson Mobile Communications AB of Lund, Sweden; or Research In Motion Limited, of Waterloo, Ontario, Canada. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

### CONCLUSION

The present invention can be easily distinguished by controlling a physical electromechanical device from a wireless touch sensitive device. The present invention can be easily distinguished by measurement and comparison of two locations of pressure causing determination of a change in two dimensions and a rate of change in a third dimension of camera image transformation. The present invention can be easily distinguished by deriving control from an interactive sensor integrated display which itself presents the image rather than requiring a separate pointing device, keyboard, or control apparatus.

A number of embodiments of the invention have been described. Nevertheless, it will be understood that various modifications may be made without departing from the spirit and scope of the invention. For example, other network topologies may be used. Accordingly, other embodiments are within the scope of the following claims.

### SEQUENCE LISTING

None

We claim:

1. A method for operation of a camera logic controller comprising:
receiving from a 3D touch screen device a plurality of touch triplet data;
determining a touchcount condition that the plurality is numerically equal to two;
on the condition that touchcount is true, determining a centerpoint equidistant between two touches, and setting an array C to said centerpoint;
determining at least one zoom command;
emitting at least one zoom command; and
emitting a pan command and a tilt command to target C; and
monitoring the 3D touch screen for touch triplet data.

2. The method of claim 1 further comprising:
determining a condition when the camera logic controller is at its zoom limit; and
emitting a stop zooming command.

3. The method of claim 1 further comprising:
on the condition that touchcount is false,
determining a currently zooming condition that the camera logic controller is emitting zoom commands;
on the condition that currently zooming is true,
emitting a stop zooming command.

4. The method of claim 1 wherein emitting at least one zoom command comprises:
determining a left tap force greater than right tap force condition;
on the condition that left tap force greater than right tap force is true,
calculating left force minus right force, and
emitting a zoom out command at a rate proportional to the magnitude of the difference between left force and right force.

5. The method of claim 4 further comprising:
on the condition that left tap force greater than right tap force is false,
calculating a right force minus left force;
emitting a zoom in command at a rate proportional to the magnitude of the difference between right force and left force.

6. The method of claim 1 further comprising:
receiving a stream of video images from a network;
transmitting the stream of video images to the 3D touch screen device; and
wherein touch triplet data comprises location coordinates and touch force in an array.

7. A system comprises:
a logic controller circuit (controller); the controller communicatively coupled to
at least one Pan Tilt Zoom (PTZ) camera, via a network; and the controller further coupled to
at least one 3D touch interface equipped display apparatus.

8. The system of claim 7 wherein the at least one PTZ camera comprises electronic circuits or mechanical linkages which respond to commands to control the orientation and size of images captured by its sensor devices.

9. The system of claim 7 wherein at least one 3D touch interface equipped display apparatus comprises a display which measures, records, and transmits pressure centered on at least two locations on its display surface and the x and y coordinate of the at least two locations.

10. The system of claim 7 wherein a network comprises a duplex data communication system which receives and delivers images in one direction and receives and delivers camera control commands in the reverse direction to and from a plurality of wireless devices.

11. The system of claim 7 wherein the logic controller circuit comprises:
a circuit to receive images captured by a video camera;
a circuit to transform received images;
a circuit to transmit transformed images to a 3D touch interface equipped display apparatus;
a circuit to receive 3D sensor data from a 3D touch interface equipped display apparatus; and
a circuit to transmit pan tilt zoom (PTZ) commands via a network interface.

12. The system of claim 11 further comprising:
a circuit to determine a new centerpoint from two touches on the 3D touch interface;
a circuit to insert a box of a current aspect ratio into the current displayed image surrounding the new centerpoint;
a circuit to transform the new centerpoint into a pan tilt zoom (PTZ) command;
a circuit to transform the current displayed image by stretching the existing image to match dimensions of the box; and
a circuit to determine a zoom component of a pan tilt zoom command from two separate forces on the 3D touch interface.

13. The system of claim 11 wherein the circuit to determine a zoom component of a PTZ command comprises:
a circuit to determine a condition when the system is zooming;
a circuit to determine a condition when the system is at a zoom limit;
a circuit to determine a condition when a left tap force exceeds a right tap force;
a circuit to determine a condition when tap forces are applied in two locations of the 3D touch interface;
a circuit to determine a magnitude of a difference between a 1^{st} tap force and a 2^{nd} tap force;
a circuit to determine a rate of zoom as a function of the magnitude of the difference in force;
a circuit to emit a zoom-in command when the left tap force exceeds a right tap force is true and to emit a zoom-out command when the left tap force exceeds a right tap force is false; and
a circuit to emit a stop zooming command when the condition that the system is at a zoom limit is true or when the condition the system is zooming is true and tap forces are applied in two locations is false.

14. A logic circuit apparatus for controlling a remote camera from a 3D touch device comprising:
a circuit to transmit a roll command through a network interface wherein a roll command is one of clock-wise angular movement and counter-clock-wise angular movement;
a circuit to receive a plurality of touches from a 3D touch device;
a circuit to trigger on the event of receiving exactly three touch data tri-tuples;
a circuit to determine a rotational pivot from the x and y coordinates of three touch data tri-tuples;
a circuit to receive the force component of touch data tri-tuples;
a circuit to determine inequalities of force applied at each of three touch data tri-tuples;
a circuit to determine an anchor point by selecting a first touch location which has less force measured than a second touch location and less force measured than a third touch location;
a circuit to determine an inequality of force measured at the two non-anchor points;
a circuit to transmit a clock-wise roll command when the second touch location has less force measured than the third touch location;
a circuit to transmit a counter-clock-wise roll command when the third touch location has less force measured than the second touch location; and
a circuit to transmit a stop roll command when the differences in force measurements is below a threshold.

15. The apparatus of claim 14 wherein the circuits are communicatively interconnected and further coupled to a camera and to a 3D touch user interface integrated with an image display which presents video data captured by the camera.

16. The apparatus of claim 15 wherein the logic circuit further comprises:
a circuit to receive images captured by a video camera;
a circuit to transform received images;
a circuit to transmit transformed images to a 3D touch interface equipped display apparatus;
a circuit to receive 3D sensor data from a 3D touch interface equipped display apparatus; and
a circuit to transmit pan tilt zoom (PTZ) commands via a network interface.
